(19) United States
(12) Patent Application Publication
(10) Pub. No.: US 2026/0192709 A1
(43) Pub. Date: Jul. 9, 2026

(54) ELECTRICAL CONTROL CIRCUITE FOR A REVERSIBLE ELECTRIC MOTOR AND CONTROL SYSTEM FOR A VEHICLE SLIDEWAY LOCKING DEVICE

(71) Applicant: FAURECIA Sièges d'Automobile, NANTERRE (FR)

(72) Inventors: Jean-Luc ROUDOT, SAINT GERMAIN LES ARPAJON (FR); Fabrice PETIT, SAINT-GEORGES DES GROSEILLERS (FR); Guillaume PETOT, LA FERRIÈRE AUX ETANGS (FR)

(21) Appl. No.: 19/442,456

(22) Filed: Jan. 7, 2026

(30) Foreign Application Priority Data
Jan. 8, 2025 (FR) 2500178

(51) Int. Cl. B60N 2/08

(52) U.S. Cl. CPC B60N 2/0881; B60N 2/0837

(57) ABSTRACT

The present disclosure relates to an electrical control circuit, the electrical circuit comprising a first stage comprising:

a freewheeling diode electrically connected between a first supply voltage terminal and a ground voltage terminal,

a load comprising a first resistor and a first diode connected in series, the load being connected in parallel with the freewheeling diode,

a first MOSFET transistor electrically connected between the freewheeling diode and the load,

a first output terminal electrically coupled to a first node between the first MOSFET transistor and the load,

a second output terminal electrically coupled to a second node between the freewheeling diode and the load.

### PRIORITY CLAIM

This application claims priority to French Patent Application No. FR2500178, filed January 8, 2025, which is expressly incorporated by reference herein.

### BACKGROUND

The present disclosure relates to an electrical circuit for controlling a reversible electric motor. The present disclosure also relates to a control system for a vehicle seat slideway locking device, the control system comprising the electrical control circuit

### SUMMARY

The present disclosure relates to an electrical control circuit, the circuit being intended to be electrically connected to an electric motor, the electrical circuit comprising a first stage including:

a freewheeling diode electrically connected between a first supply voltage terminal and a ground voltage terminal,

a load comprising a first resistor and a first diode connected in series, the load being connected in parallel with the freewheeling diode,

a first MOSFET transistor electrically connected between the freewheeling diode and the load,

a first output terminal electrically coupled to a first node, the first node being electrically connected between the first MOSFET transistor and the load,

a second output terminal electrically coupled to a second node, the second node being electrically connected between the freewheeling diode and the load, the freewheeling diode and the diode being directionally connected to block a current flowing from the first output terminal to the second output terminal.

Advantageously, this first stage enables electrical charges from the electric motor to be discharged by thermal dissipation.

Advantageously, this first stage brakes the movement of the spindle in the housing during locking.

The features disclosed in the following paragraphs may optionally be implemented. They can be implemented independently of one another or in combination with one another:

the first MOSFET transistor has a grid electrically connected to the ground voltage terminal, a source electrically connected to the load and to the first output terminal, a drain electrically connected to the first supply voltage terminal.

The first resistor is directly electrically connected to the first diode.

the electrical circuit comprises a second stage, the second stage comprising a pulse-width modulation circuit having an output generating a pulse-width modulation signal, a capacitive circuit comprising a second resistor and a first capacitor connected in series, the capacitive circuit being connected between a third supply voltage terminal and the ground voltage terminal, a NAND logic gate having a first input electrically connected to a third node between the second resistor and the first capacitor, a second input electrically connected to the output of the pulse-width modulation circuit, and an output electrically connected to the second output terminal; the capacitive circuit and the NAND gate being configured to delay the transmission of the pulse-width modulation signal to the second output terminal.

the second stage comprises a transistor connected to the output of the NAND logic gate, to the second node and to the ground voltage terminal.

the electrical circuit comprises a third stage, the third stage comprising a second MOSFET transistor having a drain electrically connected to the third node, a gate electrically connected to the first supply terminal and a source electrically connected to the ground voltage terminal;

a third MOSFET transistor having a drain electrically connected to a fourth node between the gate of the second MOSFET transistor and the third supply

voltage terminal, a gate electrically connected to the first supply terminal and a source electrically connected to the ground voltage terminal.

the third stage comprises at least one second capacitor connected between the first supply voltage terminal and the ground voltage terminal; the second MOSFET transistor being maintained in an enabled state for a defined period of time after a stoppage of the voltage supply to the first supply terminal by discharging the second capacitor, the third MOSFET transistor being in a blocked state due to the stoppage of the application of the supply voltage between the first supply terminal and the ground voltage terminal.

Advantageously, the second MOSFET transistor is kept conducting while the third transistor is blocked, so that the second capacitor discharges after a voltage supply applied between the first supply voltage terminal and the second ground voltage terminal is cut off.

the third stage further comprises a DC-DC voltage step-down converter electrically connected to the first supply voltage terminal and to the ground voltage terminal, the DC-DC voltage step-down converter being suitable for applying a voltage between the gate of the second MOSFET transistor and the ground voltage terminal that is at least 1 Volt lower than the voltage applied between the gate of the third MOSFET transistor and the ground voltage terminal.

the third stage further comprises a second diode connected between the first supply voltage terminal and the DC-DC voltage step-down converter, the second diode being directionally connected to block a current flowing from the DC-DC voltage step-down converter to the first supply voltage terminal.

The disclosure further relates to a control system for a vehicle seat slideway locking device, the slideway locking device comprising a housing, a spindle and a resilient member adapted to urge the spindle towards a slideway locking position, the control system comprising:

a linear actuator comprising a frame, a reversible electric motor and a motion transmission system capable of pulling on the spindle to control the unlocking of the locking device,

an electrical control circuit as mentioned above, the electrical control circuit being suitable for controlling the reversible electric motor of the linear actuator of the control system.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a schematic view of an example electrical circuit according to the present disclosure;

FIG. 2 is a curve representing the electric current delivered by the electric circuit shown in FIG. 1, when supplied with a constant voltage;

FIG. 3 is a schematic view of an example of a control system and locking device for a seat adapted to be controlled by the electrical control circuit according to the disclosure; and

FIG. 4 is a schematic sectional

### DETAILED DESCRIPTION

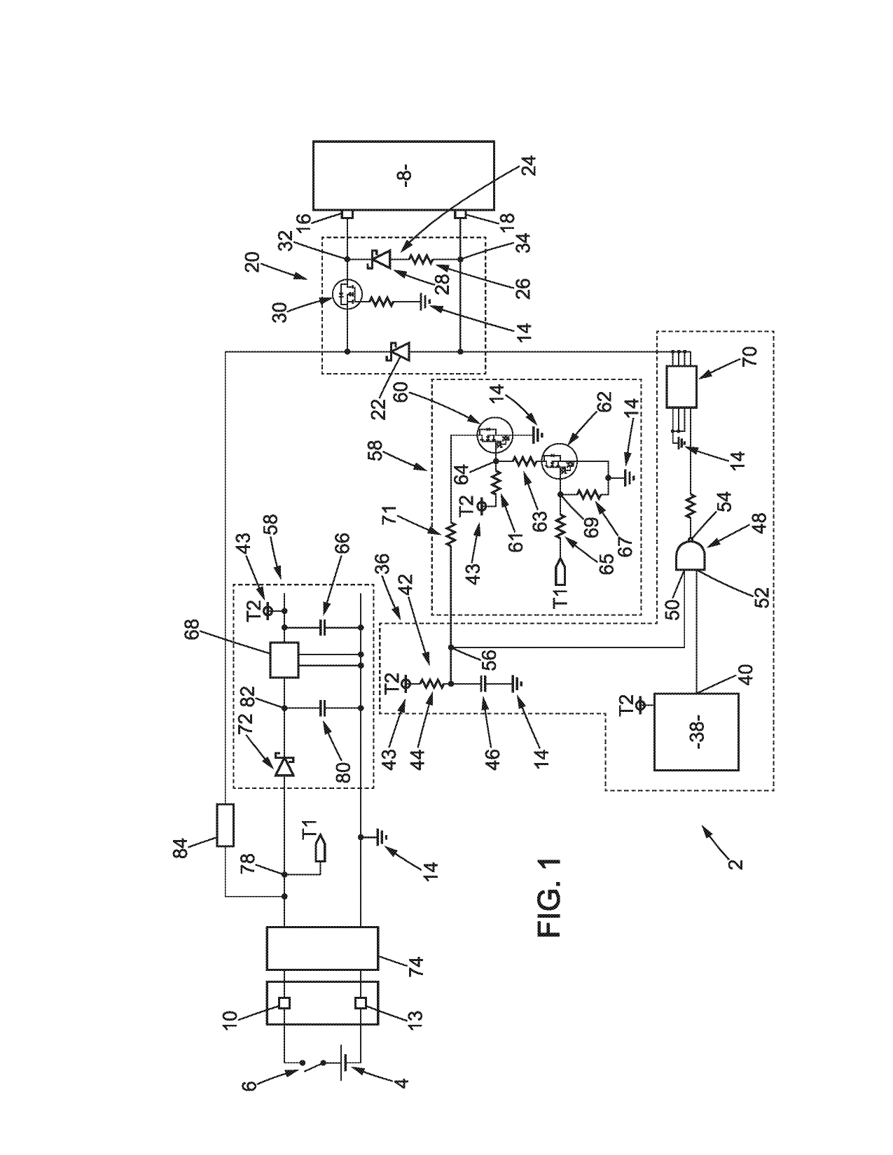

FIG. 1 shows an example of an electrical control circuit 2 according to the present disclosure.

In the embodiment shown in FIG. 1 for ease of understanding, the electrical control circuit 2 is electrically connected at the input to a voltage generator 4 and a switch 6. This electrical control circuit 2 is electrically connected at its output to a reversible electric motor 8.

This disclosure is not limited to this example described above solely for illustrative purposes; rather, it encompasses all the variants that the person skilled in the art may consider in the context of the protection sought. In this way, the electrical circuit 2 can be connected to electrical components other than the voltage generator 4, the switch 6 and the electric motor 8.

The electrical circuit 2 comprises a first supply voltage terminal 10, a second supply voltage terminal 13, a ground voltage terminal 14

The second supply voltage terminal 13 is connected to the second ground voltage terminal.

The switch 6 is connected in series with the voltage generator. The voltage generator 4 and switch 6 are connected between the first supply voltage terminal 10 and second supply voltage terminal 13.

The electrical circuit 2 further comprises a first output terminal 16 and a second output terminal 18 connected here to the electric motor 8.

The electric circuit 2 comprises a first stage 20. The first stage 20 suppresses the noise generated by the slideway locking device and/or by the motor of the control system.

The second stage 20 comprises:

a freewheeling diode 22 electrically connected between the first supply voltage terminal 10 and the ground voltage terminal 14,

a load 24 comprising a first resistor 26 and a first diode 28 connected in series,

a first MOSFET transistor 30 electrically connected between the freewheeling diode 22 and the load 24.

The freewheeling diode 22 and the first diode 28 are directionally connected to block a current flowing from the first output terminal 16 to the second output terminal 18. In other words, the freewheeling diode 22 and the first diode 28 have a cathode connected to the first output terminal 16 and an anode connected to the second output terminal 18.

The load 24 is connected in parallel with the freewheeling diode 22. When the electric circuit 2 is connected to the motor, the freewheeling diode 22 and the load 24 are connected in parallel to the motor.

The first output terminal is coupled to a first node 32. The first node 32 is electrically connected between the first MOSFET transistor 30 and the load 24.

The second output terminal 18 is coupled to a second node 34. The second node is electrically connected between the load 24 and the freewheeling diode 22.

The first MOSFET 30 comprises a gate connected to the ground voltage terminal 14 via a resistor, a source connected to the first output terminal 16 and to the load 24, and a drain connected to the first supply voltage terminal 10.

The first resistor 26 has a resistance whose value is defined as a function of the load to be controlled. Preferably, the first resistor 6 is directly electrically connected to the first diode 28, that is, without the interposition of any other electronic component.

Advantageously, this first stage discharges the electrical energy stored in the stator coils of the electric motor.

Advantageously, when this circuit is connected to the slideway locking device as described in the patent application published under number FR 3 143 465, this first stage slows down the movement of the spindle in the housing during locking and prevents the crown from slamming against the housing.

In the example shown in FIG. 1, the electrical circuit 2 further comprises a second stage 36. The second stage 36 enables the electric motor to be operated in two phases: an initial phase P1 of full-power operation, and a subsequent phase P2 of operation at rated speed. The second stage 36 comprises:

a pulse-width modulation circuit 38 having an output 40 generating a pulse-width modulation signal,

a capacitive circuit 42 comprising a second resistor 44 and a first capacitor 46 connected in series, and

a NAND logic gate 48 with a first input 50, a second input 52 and an output 54.

The capacitive circuit 42 is connected between a third supply voltage terminal 43 and the ground voltage terminal 14.

The first input 50 of the NAND logic gate is electrically connected to a third node 56 between the second resistor 44 and the first capacitor 46. The second input 52 of the NAND logic gate is electrically connected to the output 40 of the pulse-width modulation circuit. The output 54 of the NAND logic gate is electrically connected to the second output terminal 18.

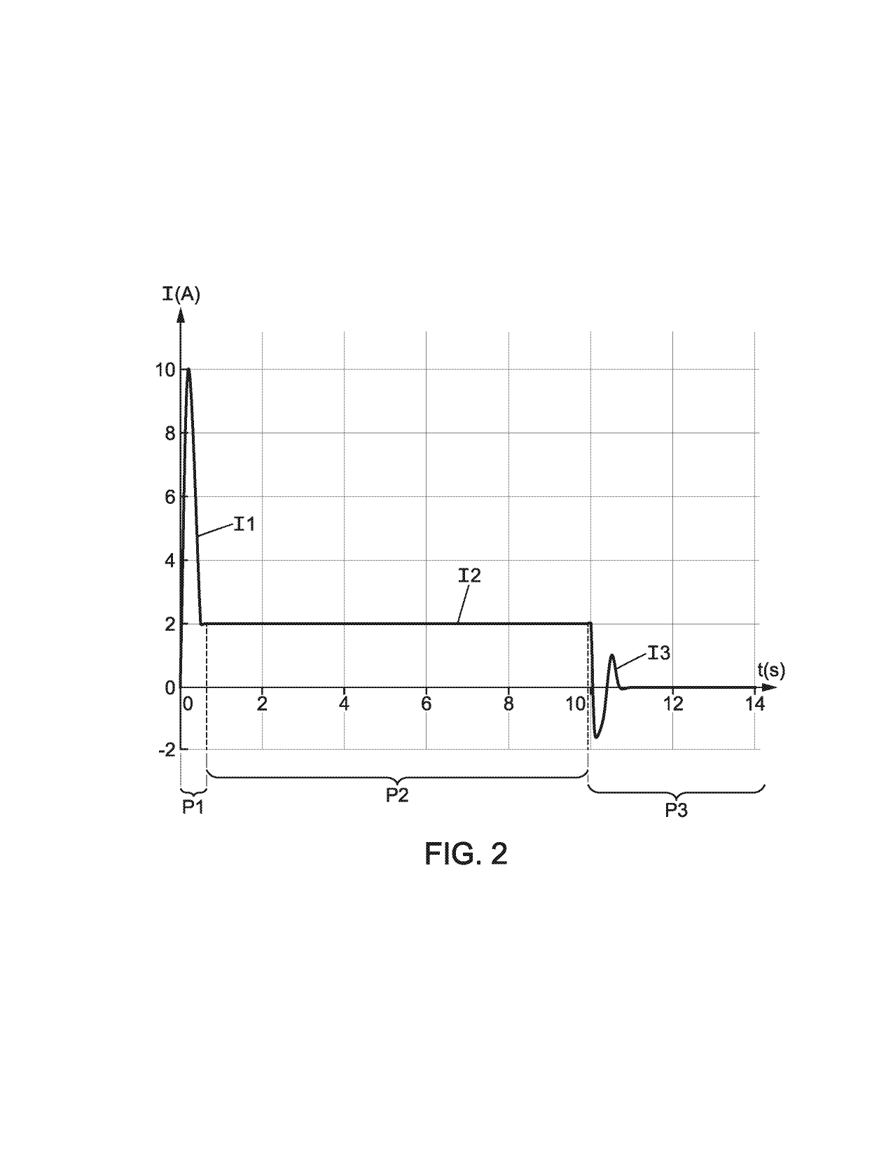

The capacitive circuit 42 and the NAND gate are configured to delay the transmission of the PWM signal to the second output terminal 18 relative to the time of application of a first voltage U1 by the voltage generator 4. This delay generates two motor supply phases P1, P2, as shown in FIG. 2, as explained below.

Preferably, the second stage 36 comprises a transistor 70 connected to the output of the NAND logic gate, to the second node 34 and to the ground voltage terminal 14. The transistor 70 is suitable for amplifying the pulse-width modulation signal from the NAND logic gate.

In the example shown in FIG. 1, the electrical circuit 2 further comprises a third stage 58. The third stage 58 allows the first capacitor 46 to be discharged after an electric motor operating cycle. In other words, the third stage resets the circuit to allow subsequent two-phase starting. The third stage 58 comprises:

a second MOSFET 60 having a drain electrically connected to the third node 56, a gate electrically connected to the first supply terminal 10, and a source electrically connected to the ground voltage terminal 14; and

a third MOSFET transistor 62 having a drain electrically connected to a fourth node 64 between the gate of the second MOSFET transistor 60 and the third supply voltage terminal 43, a gate electrically connected to the first supply terminal 10 and a source electrically connected to the ground voltage terminal 14.

Preferably, a third resistor 61 is electrically connected between the second supply voltage terminal 43 and the gate of the second MOSFET transistor 60.

Preferably, a fourth resistor 63 is electrically connected between the fourth node 64 and the drain of the third MOSFET transistor 62.

Preferably, a fifth resistor 65 is electrically connected between the second supply voltage terminal 10 and the gate of the third MOSFET transistor 62.

Preferably, a sixth resistor 67 is electrically connected to the ground voltage terminal 14 and to a seventh node 69 between the fifth resistor 65 and the gate of the third MOSFET transistor.

The source of the second MOSFET transistor and the source of the third MOSFET transistor 62 are connected to the ground voltage terminal 14.

Preferably, a seventh resistor 71 is connected between the third node 56 and the drain of the third MOSFET transistor.

Preferably, the third stage 58 comprises a DC-DC voltage step-down converter 68 electrically connected to the first supply voltage terminal 10 and to the ground voltage terminal 14. The DC-DC voltage converter 68 is able to apply a voltage, referred to as the second voltage U2, between the gate of the second MOSFET 60 and the ground voltage terminal 14. The second voltage U2 is at least 1 Volt lower than the first voltage U1 applied between the gate of the third MOSFET transistor 62 and the ground voltage terminal 14.

The DC-DC voltage step-down converter 68 is configured to convert the first input supply voltage U1 received as input into a second supply voltage U2. For example, the first voltage U1 is approximately 12 Volts. For example, the second voltage U2 is approximately equal to 5 Volts.

The gate of the second MOSFET transistor 60 is electrically connected to a fifth node 78 between the first supply terminal 10 and the DC-DC voltage step-down converter 68. The gate of the third MOSFET transistor 62 is electrically connected to the output of the DC-DC voltage step-down converter 68.

The first voltage U1, for example 12 Volts, is applied to the gate of the second MOSFET transistor 60. The second voltage U2, for example 5 Volts, is applied to the gate of the thirdMOSFETtransistor 62.

Preferably, the third stage 58 includes at least one second capacitor 66 connected between the first supply voltage terminal 10 and the ground voltage terminal 14.

The second capacitor 66 is connected to the output of the DC-DC voltage step-down converter 68.

Preferably, the third stage 58 includes a second diode 72 connected between the first supply voltage terminal 10 and the DC-DC voltage step-down converter 68. The second diode 72 is directionally connected to block a current flowing from the DC-DC voltage step-down converter 68 to the first supply voltage terminal 10.

Preferably, the third stage 58 further comprises a third capacitor 80 connected, on the one hand, to a sixth node 82 between the second diode 72 and DC-DC voltage step-down converter 68, and, on the other hand, to the ground voltage terminal 14.

The function of the third capacitor 80 is to filter the first supply voltage U1. The third capacitor 80 can also be discharged to supply the gate of the second MOSFET transistor 60, after the supply voltage U1 has been switched off.

Preferably, the electrical circuit comprises a first filter 74 electrically connected between the first supply voltage terminal 10 and the second supply voltage terminal 13, and a second filter 84 electrically connected between the first filter 74 and the first MOSFET transistor 30.

The function of the first filter 74 and the second filter is to filter the supply voltage U1.

The operation of the electrical circuit is described with reference to FIGS. 1 and 2.

On start-up, the electrical circuit 8 is used to supply full power to the electric motor 8 during a first electric motor supply phase P1. When the switch 6 is closed, the voltage generator 4 applies a first voltage U1 between the first supply voltage terminal 10 and the second supply voltage terminal 13. This first voltage U1 may advantageously be filtered by the first filter 74.

The first supply voltage U1 is applied between the drain and the gate of the first MOSFET transistor 30, which becomes conductive. The second output terminal 18 is connected to the ground voltage terminal 14.

The first supply voltage U1 is applied between the gate of the third MOSFET transistor 62 and its source.

The DC-DC voltage step-down converter 68 applies a second voltage U2 to the capacitive circuit 42, the gate of the second MOSFET transistor 60 and the input of the pulse-width modulation circuit 38.

The second MOSFET transistor 60 is in a blocked state. The third MOSFET transistor 62 is in an unblocked (saturated) state.

The pulse-width modulation circuit 38 transmits a pulse-width modulation signal to the second input 52 of the NAND logic gate 48.

At the same time, the first capacitor 46 is charged. During charging, the voltage applied to the first input 50 of the NAND logic gate is below a threshold, so that the NAND logic gate is blocked. No signal is transmitted from the output of the NAND logic gate to the transistor 70.

The electric motor is supplied with the first supply voltage U1 during the charging time of the first capacitor 46 of the capacitive circuit. As shown in FIG. 2, a current I1 supplies the electric motor 8 during a first phase P1. The electric motor operates at full power.

Once the first capacitor 46 is charged, the second motor supply phase P2 begins. Since the first capacitor 46 is charged, the voltage at the first input 50 of the NAND logic gate increases and becomes sufficient to unlock the NAND logic gate.

A pulse-width modulation signal is then applied to the second output terminal 18 so that the electric motor is supplied with a third supply voltage U3. The third supply voltage U3 is lower than the first supply voltage U1. The value of the third supply voltage U3 depends on the duty cycle of the pulse-width modulation signal. In this way, the second stage 36 supplies the electric motor 8 with full power during the first motor supply phase P1, and then supplies the electric motor with less than full power during a second motor supply phase P2. As shown in FIG. 2, a current I2 flows through the electric motor 8. The intensity of this current I2 is less than the intensity of the current I1.

The duration of the first motor supply phase P1 is defined by the value of the second resistor 44 and the value of the first capacitor 46. For example, the second resistor 44 has a resistance between 40 and 70 kiloohms. Preferably, the second resistor 44 has a resistance of 56 kiloohms. For example, the first capacitor 46 has a capacitance of between 1 and 20 microfarads. Preferably, the first capacitor 46 has a capacitance of 10 microfarads.

The third motor supply phase P3 begins when the switch 6 is opened and the electrical circuit 2 is no longer supplied with the first supply voltage U1.

The first supply voltage U1 is no longer applied to the drain of the first MOSFET transistor 30, which blocks itself, i.e. becomes non-conducting. The spring(s) of the locking device move(s) the spindle by resilient stress. Because of the motion transmission chain, the electric motor becomes a generator. The electric motor 8 generates a current I3 from the second output terminal 18 to the first output terminal 16. As the first MOSFET transistor 30 is open, i.e. not conducting, current I3 flows through the load 24. Current I3 is dissipated as heat by the first resistor 26. Dissipating the current I3 through the first resistor 26 slows down the movement of the spindle. As a result, the locking device no longer generates noise.

At the same time, the first supply voltage U1 is no longer applied to the gate of the third MOSFET transistor 62. The third MOSFET transistor 62 goes into a blocked state. The second capacitor 66 and the third capacitor 80 discharge so that a voltage is maintained at the gate of the second MOSFET transistor 60. The second MOSFET transistor 60 is in a conducting state. The first capacitor 66 discharges itself by transmitting electrical charges to the ground voltage terminal 14. In this way, the third stage discharges the first capacitor 4 and resets the second stage to enable a two-phase start-up, as shown in FIG. 2.

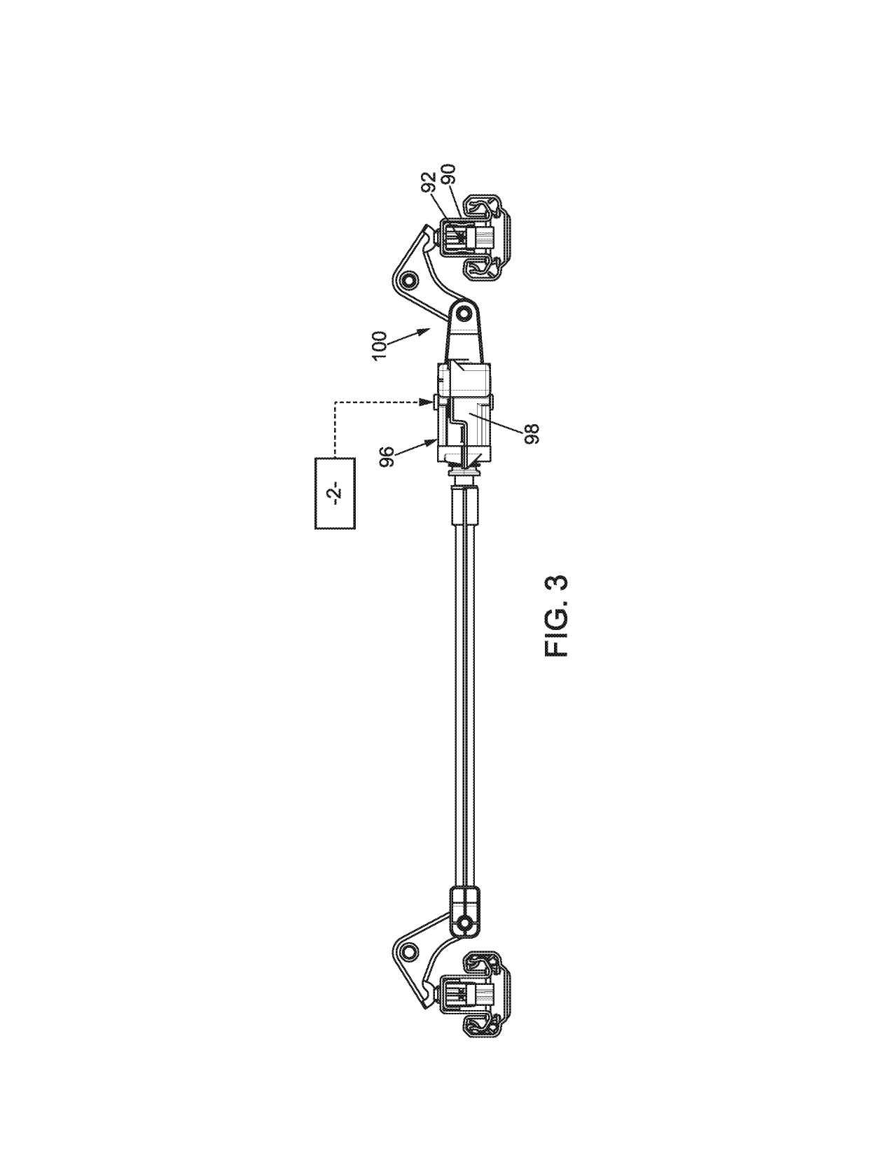

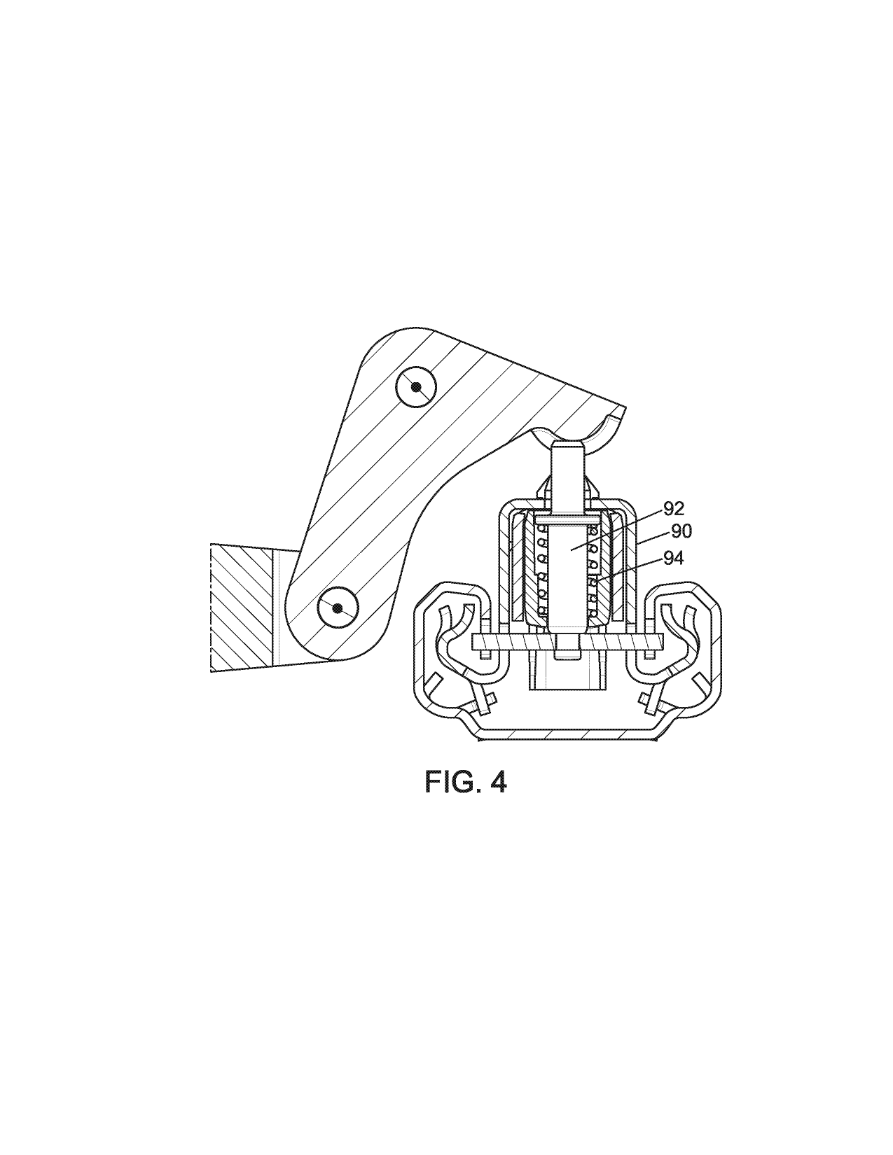

With reference to FIGS. 3 and 4, the disclosure also relates to a control system 86 for a vehicle seat slideway locking device 88.

The slideway locking device 88 comprises a housing 90, a spindle 92 and a resilient element 94 adapted to push the spindle towards a slideway locking position. The resilient element 94 is a spring.

The command system 86 comprises:

a linear actuator 96 comprising a frame 98, a reversible electric motor 8 not shown in FIG. 3 and a motion transmission system 100 capable of pulling on the spindle 92 of the slideway locking device to order the unlocking of the locking device,

an electrical control circuit 2, configured according to the features described above. The electrical command circuit is configured to control the linear actuator's reversible electric motor.

Alternatively, the electrical control circuit 2 can be used to control an electric motor of any mechanical mechanism.

A vehicle seat may be mounted on slideways, to adjust the longitudinal position of the seat in the passenger compartment. For this purpose, the seat is mounted on movable profiles via feet. Each movable profile is slidably mounted in a fixed profile to form a slideway. The fixed section is fixed to the floor of the motor vehicle.

A comparative device for adjusting the longitudinal position of the vehicle seat can be driven by an electric motor.

The comparative system for adjusting the longitudinal position of the seat can be locked, for example, by a slideway locking device and a control system.

The comparative locking device comprises a housing with a recess, a spindle and a spring arranged in the recess. The spindle is fitted with a crown. The spindle is configured to move vertically in the housing to lock or unlock the position of the moving profile relative to the fixed profile. The spring resiliently forces the spindle into a locking position.

The comparative locking device comprises a reversible electric motor and a pivoting arm driven by the electric motor to move the spindle.

When the comparative control system's electric motor is powered down, the spring displaces the spindle to a position that locks the movement of the moving profile relative to the fixed profile. This displacement causes a noise. This noise may be caused by the impact of the spindle crown against the housing during locking and/or the discharge of electrical charges from the electromagnetic coils of the stator of the electric motor.

This noise is annoying for the seat user.

A first aim of the present disclosure is to suppress this noise.

Alternatively or additionally, the comparative control system may comprise a processor. The processor can be configured to supply the electric motor with full power for a set period of time, to move the swivel arm from the locking position to the unlocking position of the movable profile relative to the fixed profile. Then, the comparative processor can be configured to power the electric motor at less than full power rating, to hold the swivel arm in its unlocked position when the seat is moved.

However, a processor is expensive.

A second aim of the present disclosure is to replace this processor with a less expensive electrical circuit.

Furthermore, a comparative control circuit for an electric motor with reduced energy loss. In this control circuit, the freewheeling diode is replaced by a transistor T2, which generates less heat loss than the freewheeling diode. Transistor T2 is controlled by a driver circuit 21. The driver circuit 21 comprises a transistor T3. The source of transistor T3 is connected to the ground, the drain of transistor T3 is connected to the resistor R2, and the gate of transistor T3 is connected to the motor and to the transistor T1.

The comparative control circuit does not include a resistor and diode connected in parallel to the motor and a freewheeling diode connected parallel to the motor. Resistor R2 and diode D2 of the driver circuit 21 serve a different purpose. Resistor R2 and diode D2 in the driver circuit 21 do not dissipate the recirculating current from the motor as heat when the motor is no longer powered and the force accumulated in the spring drives the motor. Furthermore, the function of the comparative control circuit differs from the function of the control circuit according to the present disclosure. Specifically, the control circuit according to the present disclosure dissipates the recirculation current as heat in the event of a motor power failure by introducing an impedance load across the motor terminals through the disconnection of the freewheeling diode by transistor 30. In contrast, the control circuit in D1 minimizes heat loss by implementing a low-impedance circuit.

The present disclosure relates to an electrical control circuit, the circuit being intended to be electrically connected to an electric motor, the electrical circuit comprising a first stage including:

a freewheeling diode electrically connected between a first supply voltage terminal and a ground voltage terminal,

a load comprising a first resistor and a first diode connected in series, the load being connected in parallel with the freewheeling diode,

a first MOSFET transistor electrically connected between the freewheeling diode and the load,

a first output terminal electrically coupled to a first node, the first node being electrically connected between the first MOSFET transistor and the load,

a second output terminal electrically coupled to a second node, the second node being electrically connected between the freewheeling diode and the load, the freewheeling diode and the diode being directionally connected to block a current flowing from the first output terminal to the second output terminal.

Advantageously, this first stage enables electrical charges from the electric motor to be discharged by thermal dissipation.

Advantageously, this first stage brakes the movement of the spindle in the housing during locking.

The features disclosed in the following paragraphs may optionally be implemented. They can be implemented independently of one another or in combination with one another:

the first MOSFET transistor has a grid electrically connected to the ground voltage terminal, a source electrically connected to the load and to the first output terminal, a drain electrically connected to the first supply voltage terminal.

The first resistor is directly electrically connected to the first diode.

the electrical circuit comprises a second stage, the second stage comprising a pulse-width modulation circuit having an output generating a pulse-width modulation signal, a capacitive circuit comprising a second resistor and a first capacitor connected in series, the capacitive circuit being connected between a third supply voltage terminal and the ground voltage terminal, a NAND logic gate having a first input electrically connected to a third node between the second resistor and the first capacitor, a second input electrically connected to the output of the pulse-width modulation circuit, and an output electrically connected to the second output terminal; the capacitive circuit and the NAND gate being configured to delay the transmission of the pulse-width modulation signal to the second output terminal.

the second stage comprises a transistor connected to the output of the NAND logic gate, to the second node and to the ground voltage terminal.

the electrical circuit comprises a third stage, the third stage comprising a second MOSFET transistor having a drain electrically connected to the third node, a gate electrically connected to the first supply terminal and a source electrically connected to the ground voltage terminal;

a third MOSFET transistor having a drain electrically connected to a fourth node between the gate of the second MOSFET transistor and the third supply voltage terminal, a gate electrically connected to the first supply terminal and a source electrically connected to the ground voltage terminal.

the third stage comprises at least one second capacitor connected between the first supply voltage terminal and the ground voltage terminal; the second

MOSFET transistor being maintained in an enabled state for a defined period of time after a stoppage of the voltage supply to the first supply terminal by discharging the second capacitor, the third MOSFET transistor being in a blocked state due to the stoppage of the application of the supply voltage between the first supply terminal and the ground voltage terminal.

Advantageously, the second MOSFET transistor is kept conducting while the third transistor is blocked, so that the second capacitor discharges after a voltage supply applied between the first supply voltage terminal and the second ground voltage terminal is cut off.

the third stage further comprises a DC-DC voltage step-down converter electrically connected to the first supply voltage terminal and to the ground voltage terminal, the DC-DC voltage step-down converter being suitable for applying a voltage between the gate of the second MOSFET transistor and the ground voltage terminal that is at least 1 Volt lower than the voltage applied between the gate of the third MOSFET transistor and the ground voltage terminal.

the third stage further comprises a second diode connected between the first supply voltage terminal and the DC-DC voltage step-down converter, the second diode being directionally connected to block a current flowing from the DC-DC voltage step-down converter to the first supply voltage terminal.

The disclosure further relates to a control system for a vehicle seat slideway locking device, the slideway locking device comprising a housing, a spindle and a resilient member adapted to urge the spindle towards a slideway locking position, the control system comprising:

a linear actuator comprising a frame, a reversible electric motor and a motion transmission system capable of pulling on the spindle to control the unlocking of the locking device,

an electrical control circuit as mentioned above, the electrical control circuit being suitable for controlling the reversible electric motor of the linear actuator of the control system.

The present disclosure relates to an electrical control circuit (2), the electrical circuit comprising a first stage (20) comprising:

a freewheeling diode (22) electrically connected between a first supply voltage terminal (10) and a ground voltage terminal (14),

a load (24) comprising a first resistor (26) and a first diode (28) connected in series, the load being connected in parallel with the freewheeling diode,

a first MOSFET transistor (30) electrically connected between the freewheeling diode and the load,

a first output terminal (16) electrically coupled to a first node (32) between the first MOSFET transistor and the load,

a second output terminal (18) electrically coupled to a second node (34) between the freewheeling diode and the load.

1. An electrical control circuit, the circuit being electrically connected to an electric motor, the electrical circuit comprising a first stage comprising:
a freewheeling diode electrically connected between a first supply voltage terminal and a ground voltage terminal,
a load comprising a first resistor and a first diode connected in series, the load being connected in parallel with the freewheeling diode,
a first MOSFET transistor electrically connected between the freewheeling diode and the load,
a first output terminal electrically connected to a first node, the first note being electrically connected between the first MOSFET transistor and the load,
a second output terminal electrically connected to a second node, the second node being electrically connected between the freewheeling diode and the load, the freewheeling diode and the diode being directionally connected to block a current flowing from the first output terminal to the second output terminal.

2. The electrical control circuit of claim 1, wherein the first MOSFET transistor has a grid electrically connected to the ground voltage terminal, a source electrically connected to the load and to the first output terminal, a drain electrically connected to the first supply voltage terminal.

3. The electrical control circuit of claim 1, wherein the first resistor is directly electrically connected to the first diode.

4. The electrical control circuit of claim 1, further comprising a second stage, the second stage comprising:
a pulse-width modulation circuit having an output generating a pulse-width modulation signal,
a capacitive circuit comprising a second resistor and a first capacitor connected in series, the capacitive circuit being connected between a third supply voltage terminal and the ground voltage terminal,
a NAND logic gate having a first input electrically connected to a third node between the second resistor and the first capacitor, a second input electrically connected to the output of the pulse-width modulation circuit, and an output electrically connected to the second output terminal;
the capacitive circuit and the NAND gate being configured to delay transmission of the PWM signal to the second output terminal.

5. The electrical control circuit of claim 4, wherein the second stage comprises a transistor connected to the output of the NAND logic gate, to the second node and to the ground voltage terminal.

6. The electrical control circuit of claim 4, further comprising a third stage, the third stage comprising:
a second MOSFET transistor having a drain electrically connected to the third node, a gate electrically connected to the first supply terminal, and a source electrically connected to the ground voltage terminal;
a third MOSFET transistor having a drain electrically connected to a fourth node between the gate of the second MOSFET transistor and the third supply voltage terminal, a gate electrically connected to the first supply terminal and a source electrically connected to the ground voltage terminal.

7. The electrical control circuit of claim 6, wherein the third stage comprises at least one second capacitor connected between the first supply voltage terminal and the ground voltage terminal; the second MOSFET transistor being maintained in an enabled state for a defined period after the power supply to the first supply terminal is cut off, by discharge of the second capacitor, the third MOSFET transistor being in a blocked state due to the stoppage of the application of the supply voltage between the first supply terminal and the ground voltage terminal.

8. The electrical control circuit of claim 6, wherein the third stage further comprises a DC-DC step-down converter electrically connected to the first supply-voltage terminal and to the ground-voltage terminal, the DC-DC step-down converter being configured to apply, between the gate of the second MOSFET transistor and the ground-voltage terminal, a voltage at least 1 volt lower than that applied between the gate of the third MOSFET transistor and the ground-voltage terminal.

9. The electrical control circuit of claim 6, wherein the third stage further comprises a second diode connected between the first supply voltage terminal and the DC-DC voltage step-down converter, the second diode being directionally connected to block a current flowing from the DC-DC voltage step-down converter to the first supply voltage terminal.

10. A control system for a vehicle seat slideway locking device, the slideway locking device comprising a housing, a spindle and a resilient member adapted to urge the spindle towards a slideway locking position, the control system comprising:
a linear actuator comprising a frame, a reversible electric motor, and a motion transmission system configured to pull on the spindle to order the unlocking of the locking device,
the electrical control circuit configured according to claim 1, the electrical control circuit being suitable for controlling the reversible electric motor of the linear actuator of the control system.
